(19) United States
(12) Patent Application Publication
(10) Pub. No.: US 2023/0192254 A1
(43) Pub. Date: Jun. 22, 2023

(54) DEVICE AND METHOD FOR UNDERWATER SAMPLING

(71) Applicant: RUSSEL 10984 (PTY) LTD, Port Elizabeth (ZA)

(72) Inventors: Russel James RAUTENBACH, Port Elizabeth (ZA); Francois Petrus HEUNIS, Port Elizabeth (ZA); Alwyn DU PLESSIS, Paarl (ZA)

(21) Appl. No.: 17/998,621

(22) PCT Filed: May 13, 2021
(86) PCT No.: PCT/IB2021/054125

§ 371 Date: Nov. 11, 2022

(30) Foreign Application Priority Data
May 13, 2020 (ZA) 2020/02705

(51) Int. Cl. B63G 8/00; G05D 1/10; H02G 1/10

(52) U.S. Cl. CPC B63G 8/001; G05D 1/10; H02G 1/10; B63G 2008/007

(57) ABSTRACT

A device and method for sampling underwater parameters is provided. The device is configured to be removably secured to, and navigated along a length of, an underwater cable during an underwater cable recovery operation. The device may include one or more sampling elements configured to sample underwater parameters while the device moves along the length of the underwater cable. The device may include a computing unit in communication with the one or more sampling elements which is configured to receive output data of the one or more sampling elements and record the output data for subsequent analysis.

### CROSS-REFERENCE TO RELATED APPLICATIONS

This application claims priority from South African provisional patent application number 2020/02705 filed on 13 May 2020, which is incorporated by reference herein.

### FIELD OF THE INVENTION

This invention relates to a device for underwater use. More specifically the invention relates to a device for use in sampling and recording parameters during underwater operations. Even more specifically the invention relates to a device for recording continuous environmental data during underwater cable recovery.

### BACKGROUND TO THE INVENTION

It is well known that approximately 70% of Earth's surface is covered by the ocean. Of this 70% it has widely been reported that a mere 5% of Earth's oceans have been explored and charted. In particular, the ocean below the surface remains mostly undiscovered and unseen by humans.

Ocean exploration, especially sub-surface, is a difficult and expensive task. Not only is the ocean incredibly vast, but the technologies that have been used to map the oceans and ocean floors are relatively new. Some of the most advanced systems such as deep-sea submarines, advanced sonar, scientific buoys, remotely operated vehicles, and the like have only been used and developed over the last four to five decades.

Satellite imaging has been used in order to record and map water temperatures, water levels and water colour in order to determine if there is any plant or sea life. However, satellites are mostly useful to study the surface of the ocean and are much less effective in studying the sub-surface ocean environment.

Before technological advancements human divers would often dive and explore the oceans on their own. However, due to several factors such as nitrogen narcosis, oxygen toxicity, decompression sickness and high-pressure nervous syndrome, well-known to the diving community, the depths at which humans can dive are very limited. The average technical deep dive is approximately 60 meters. Accordingly, there exists a need for other methods of ocean exploration in order to be able to gather data regarding the oceans.

The inability to clearly see under water, due to light that does not permeate deep into open water, places further constraints on the sub-surface studying of the ocean. It is well documented that after 200 meters, known as the photic zone, euphotic zone, epipelagic zone or sunlight zone, in diving parlance, light begins to decline significantly.

Due to the dangers associated with deep ocean exploring, various other methods have been tested. Some of these methods include the use of submarines and shipping vessels dragging data capturing vehicles by means of a connection line, often referred to as an underwater umbilical cord, to explore the deep waters. However, both methods are severely limited due to exceptional costs, navigation difficulties and limited access due to size constraints.

In order to alleviate the problems with the above-mentioned methods most recent research have been focussed on the development of using remotely operated vehicles (ROVs) to study the ocean and harvest data. The use of ROVs such as Unmanned Surface Vehicles (USVs) and Unmanned Underwater Vehicles (UUVs) have allowed scientists to discover and learn more about the oceans and the sub surface environment. ROVs have made it possible to gain a lot of valuable data relating to the twilight zone at depths of between 200 m and 1000 m. Due to the relatively new nature of the ROVs they are often very expensive with limited capabilities. For example, ROVs are known to undergo component failures and communication losses at great depths which could lead to severe monetary and data losses. It is well known that water distorts signals and effective communication with ROVs in deep water applications remain a major hurdle for the effective use of such ROVs in deep water research applications.

Due to the above-mentioned shortcomings, the so-called “midnight zone” remains mostly unexplored and ROVs are often not capable of operating at such depths.

Accordingly, the applicant considers there to be room for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a device for sampling underwater parameters, the device comprising an engagement formation for removably engaging an underwater cable and one or more sampling elements configured to operatively sample the underwater parameters, wherein the device is configured to move along the underwater cable to where the cable is positioned underwater.

The device may include a computing unit in communication with the one or more sampling elements, the computing unit may be configured to receive output data from one or more of the sampling elements and record the output data as and where appropriate.

The sampling elements may include one or more data capturing elements, sample collectors or the like.

The device may be removably secured to the underwater cable by means of the engagement formation which may accommodate movement of the device relative to the underwater cable. In some embodiments the engagement formation may include at least one v-groove wheel configured to engage the cable and guide the device along a length of the cable.

In one embodiment the device may be powered by the underwater cable via an electrical connection created between the device and the cable. In another embodiment the device may be battery powered by, for example, a rechargeable battery.

The device may include a power generating unit configured to power the device and/or recharge the battery during use of the device. The power generating unit may be a friction power generating unit, such as a dynamo, configured to generate power in response to frictional movement of the device along the underwater cable.

The one or more sampling elements may include one or more of: a camera; a sensor, such as a depth, temperature and/or pressure sensor; sound emitter and receiver groups; radar; a micro particle analyser; soil, water or other sample collectors and a timing device for generating time data, such as time stamps.

The computing unit of the device may include a storage component in which output data from one or more of the sampling elements may be recorded. In one embodiment the storage component may be an on-board storage device. Alternatively, in some embodiments, the storage component may be a database maintained at a remote computing device.

The computing unit may further include a communication component. The communication component may be configured to transmit the output data to the remote computing device.

In some embodiments the communication component may be configured to transmit the output data to the remote computing device via a repeater provided in the underwater cable. The repeater may amplify or reconstruct the output data to be relayed to the remote computing device, which may have the advantage of preserving output data quality and reducing output data losses.

The device may include a location determining device which may be controlled and monitored from the remote computing device. The location determining device may be configured to determine the location of the device and to transmit location data to the computing device so as to associate the location data with the output data and to record and store the location data and the output data on the storage device.

The device may further include: a stabilising mechanism, such as a gyroscope and fins, to facilitate accurate navigation of the device; and/or a safety mechanism configured to, in response to a predetermined pressure or temperature acting on the device, release the device from the underwater cable so as to prevent damage to the device.

In some embodiments, the device may include a controlling unit for navigating movement of the device.

The stabilising mechanism and/or the safety mechanism may be controlled by the controlling unit which may be in communication with the computing unit.

In some embodiments, the underwater cable may be a pre-existing underwater cable, such as, but not limited to, a submarine telecommunication cable. Alternatively, the underwater cable may be a custom cable configured to be deployed into a body of water and used as a guide for guiding movement of the device.

The device may be a portable device manufactured from a lightweight corrosive resistant material having a high strength to density ratio.

In accordance with a further aspect of the invention there is provided a method for sampling underwater parameters with an underwater sampling device, the method comprising the steps of:
releasably securing the sampling device to an underwater cable;
navigating the sampling device along the length of the underwater cable; and
sampling underwater parameters using one or more sampling elements configured to operatively sample underwater parameters during navigation of the sampling device along the length of the underwater cable.

The method may include transmitting sampling data to a storage component and recording the sampling data to a database. The storage component may be associated with the device or may be a remote storage component.

The method may be conducted while recovering the underwater cable, such as a pre-existing underwater cable, from a surface vessel and may include: securing the sampling device to a raised end of the underwater cable; allowing the sampling device to move down the cable towards a submerged section thereof; periodically raising the sampling device to the vessel; and retrieving recorded sample data from the sampling device while the device is in close proximity to or on the vessel.

Embodiments of the invention will now be described, by way of example only, with reference to the accompanying drawings.

### BRIEF DESCRIPTION OF THE DRAWINGS

In the drawings:

FIG. 1 is a perspective view from the top, front, left of a first example embodiment of a device for sampling underwater parameters;

FIG. 2 is a perspective view from the bottom, rear, left of the device of FIG. 1;

FIG. 3 is a rear view of the device of FIG. 1;

FIG. 4 is a front view of the device of FIG. 1;

FIG. 5 is a bottom view of the device of FIG. 1;

FIG. 6 is a top view of the device of FIG. 1;

FIG. 7 is a perspective view of a second example embodiment of a device for sampling underwater parameters;

FIG. 8 is a section view of the device of FIG. 7.

FIG. 9 is a diagrammatic representation of an example cable recovery system in which the device of FIG. 1 may be used;

FIG. 10 is a flow diagram of an example method of steps carried out during deployment and operation of the device; and

FIG. 11 is a high-level component diagram of the computing unit of FIG. 10.

### DETAILED DESCRIPTION WITH REFERENCE TO THE DRAWINGS

In this specification the term “sampling” should be broadly construed to include the collection of data by means of sensors, the collection of underwater samples such as soil or water samples, and the like, but also the recording of video, optical or audio signals with suitable recording devices. Likewise, the term “parameters” should be construed to include environmental conditions and/or data such as, but not limited to, temperature, atmospheric pressure, turbidity and the like, as well as physical samples such as soil, water, plant or other organic matter samples, to name but a few. It will be appreciated by those skilled in the art that “samples” of any underwater matter or conditions could be collected and/or recorded by a sampling device according to the invention.

Any reference in this specification to the “device” should be interpreted as meaning a data collection and/or sampling device according to the present disclosure. Where reference is made to a “data capturing device” this should be construed to include a device that can conduct both data capturing and sample collection. The terms “data collecting/collection device” and “sampling device” will therefore be used interchangeably. Likewise, the term “data capturing elements” should be construed to include sample collection elements, except where it appears from the context to be inappropriate.

The invention provides a data capturing and sampling device and method for recording underwater data and collecting underwater samples, which may provide interested persons, such as fisheries, scientists, deep water divers, etc., with parameters relating to the underwater environment and may facilitate a greater understanding of underwater systems and phenomena.

The device may, in use, be secured to an underwater cable, such as a pre-existing underwater cable. The oceans have many cables, stretching over millions of kilometres, which are laid on the ocean floor between land-based stations to carry telecommunication signals across stretches of ocean and sea. These underwater cables are known in the art as submarine communication cables and have been used in telecommunication operations since the 1850's. Many of these cables have gone out of service but still include valuable materials and may be in a working condition. Due to the convenient location, extreme lengths and availability of these cables, these cables are of much value.

In the present application such cables may be used as guiding lines for the data capturing and sampling device during movement navigation of the device. In order for the cables to be used as guiding lines, the data capturing and sampling device may have to be secured to the cables. Accordingly, the device may include an engagement formation allowing the device to be removably secured to the underwater cable. The device may also include a safety mechanism configured to release the device from the underwater cable when required. The safety mechanism may be configured to facilitate automatic release of the device from the underwater cable when extreme conditions, such as extreme pressures or temperatures, are detected so as to preserve the device and limit damage thereto.

In some embodiments, the device may be secured to a custom cable configured to be deployed into a body of water. Such a custom cable may be a weighted cable or any standard cable having a weighted end. In such embodiments, underwater data of areas in which no pre-existing underwater cables exist may be captured in a similar fashion and using like methods as when underwater cables are used. The custom cable may, for example, be deployed by securing an end of the rope to a pulley and dropping the weighted end of the cable into the body of water. After waiting a period for the weighted end to reach a preferred depth, the device may be secured to the custom cable, and the custom cable may be used as a guiding line during movement navigation of the device.

The device may include one or more sampling elements including, for example, cameras, sensors, radar, particle analysers, soil sample collectors, sound emitters and receivers (sonar), etc., which are configured to sample underwater parameters when the device is in use. Sampling the underwater parameters may include harvesting/collecting and recording the samples which relate to the underwater environment. The recorded or collected samples could be any samples such as radar images or readings, pictures, videos, temperature readings, pressure readings, radiation readings, soil analysis, soil, water or other fluid samples or the like. One or more of the sampling elements may be in electronic communication with a computing unit to which the recorded data may be transmitted. The computing unit may include a storage component, such as a data storage device which includes flash memory (USB) or a database, in which the data may be stored and accessed by an end user.

As envisaged above, in some embodiments, one or more of the sampling elements may be configured to collect physical underwater samples, such as soil samples, which may be used to, for example, conduct sediment microbiological tests, methane oil and gas exploration, nitrate and phosphate tests, or the like.

The computing unit may include a communication component which is configured to transmit harvested output data relating to the sampled parameters of the data capturing elements to a remote computing device. This may enable the data to be monitored and/or recorded in near-real time. For example, the data storage device may store the data for later use, whilst the communication component may enable monitoring of the data by an end user in near-real time. In some embodiments, the communication component may be used to transmit the output data to a database maintained by the remote computing device. In order to account for the possible loss of signal and communication between the device and the remote computing device, the communication unit may be configured to communicate with a repeater located on the underwater cable. The communication unit may use the repeater to amplify the signal to be transmitted to the remote computing device. By using the repeaters located on the underwater cables, signals being exchanged between the remote computing device and the computing unit may be transmitted over greater distances. For example, in order to navigate the device, a control unit in communication with the computing unit needs to receive control signals over great distances, and this is made possible by using the repeaters located on the pre-existing cables. The device may further include a plurality of navigation elements such as a gyroscope, fins or the like to facilitate accurate navigation of the device.

The computing unit and data capturing elements enable real-time recording of underwater environmental data. The data may be stored and recorded into a database in a record associated with the device and accessed by an authorised end user. The data may enable the end user to study previously undiscovered areas of the ocean and may find use in applications that include, mapping the ocean bed in relation to cable paths, find and explore terrain for new organisms, research ecological function of underwater communities, conduct methane oil and gas exploration, record video footage for documentary purposes, to fully understand cable breaks due to the terrain, to log extensive amounts of underwater data and to understand climate change, to name a few.

It should be appreciated that the device described herein may be versatile and may find application for example in river exploration, dam exploration, etc. As a result, the term “ocean” should be interpreted to be any body of water and should not be limited to ocean water.

The term “underwater cable” should be interpreted to mean any cable which can be found underwater and should not be limited to submarine telecommunication tables.

The data capturing and/or sampling device will now be described with reference to the accompanying figures, wherein like reference numerals are used to indicate like features and components.

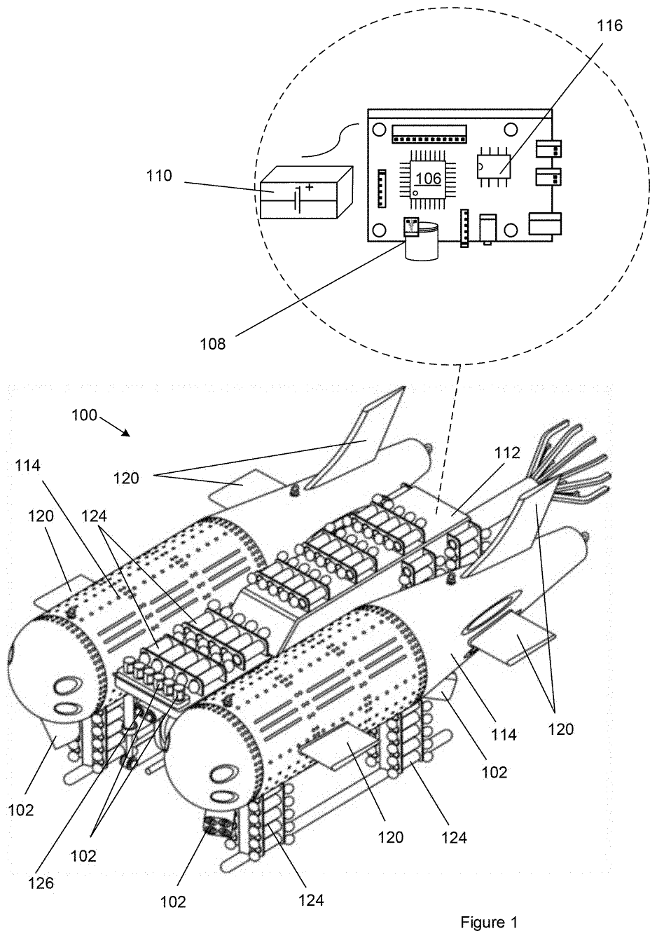

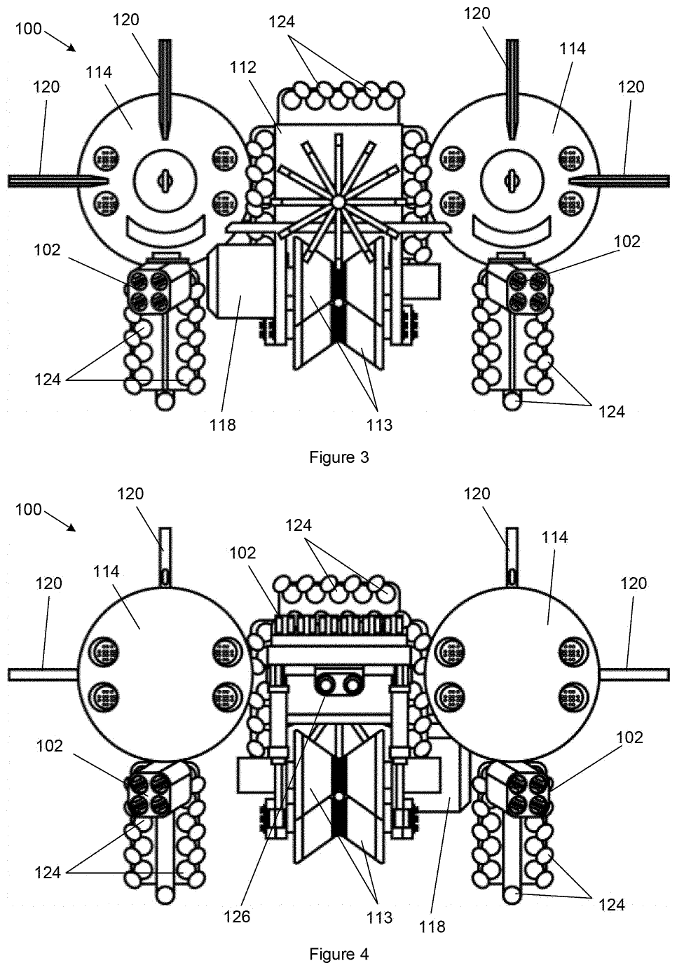

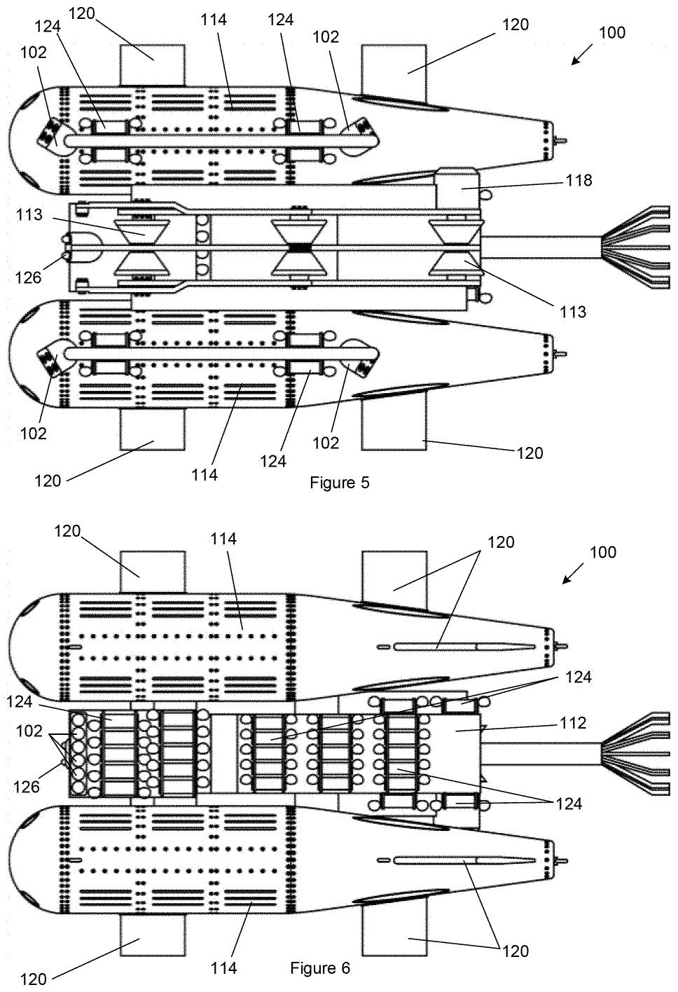

FIGS. 1 through 6 show an illustration of an example embodiment of an underwater sampling device (100) in accordance with the invention from different perspectives, and like features are indicated by like reference numerals. The device (100) may include one or more sampling elements (102), an engaging formation (104) for securing the device to an underwater cable, a computing unit (106), a storage component (108) and a power source (110).

The device may include a protective casing (112) which houses at least some of the components of the device. The casing (112) needs to be fully sealable and configured to withstand extreme sub-surface conditions, such as extreme pressures and temperatures associated with deep water operations. Considering that the device (100) will be used in sub-surface marine applications, a person skilled in the art would appreciate that the device (100) may be a waterproof device capable of complete water submersion. Further considering the corrosive nature of sea water and the pressure to which the device (100) may be exposed, the device may ideally be manufactured from materials that preferably have high resistance to corrosion and a high strength-density ratio.

Accordingly, it should be appreciated that the device may be manufactured from plastics having high strength-density ratios, such as acrylonitrile butadiene styrene plastics, or from metallic alloys, such as nickel based metallic alloys containing chromium and other elements. It should be appreciated that the protective casing (112) may be integrally formed with a body (114) of the device, or it may be a casing removably securable to the body.

In some embodiments, at least some of the electrical components of the device (100) may be housed in oil-filled, water tight, or otherwise hermitically sealed compartments, or one-atmosphere compartments so as to protect these components from being contaminated with seawater, which may cause corrosion and other circuitry issues, or being damaged by the extreme pressures exerted on the device during deep water applications. Such a compartment for protecting the electrical components may preferably be manufactured from any hydrophobic material or any material capable of being coated with a hydrophobic coating such that water may be repelled from the device over an extended period of use. Skilled artisans would appreciate that the compartment may be made from any material including rigid or resilient materials such as plastic, light rubber, polymeric or composite materials, metal or the like.

Ideally, the device (100) should be a compact and light-weight device so as to enable quick deployment and enhance portability. However, it should be appreciated that, in some embodiments, the device may be a compact device of high mass such that the device may simply slide down the length of the cable without requiring a control unit for movement navigation, as described in more detail below.

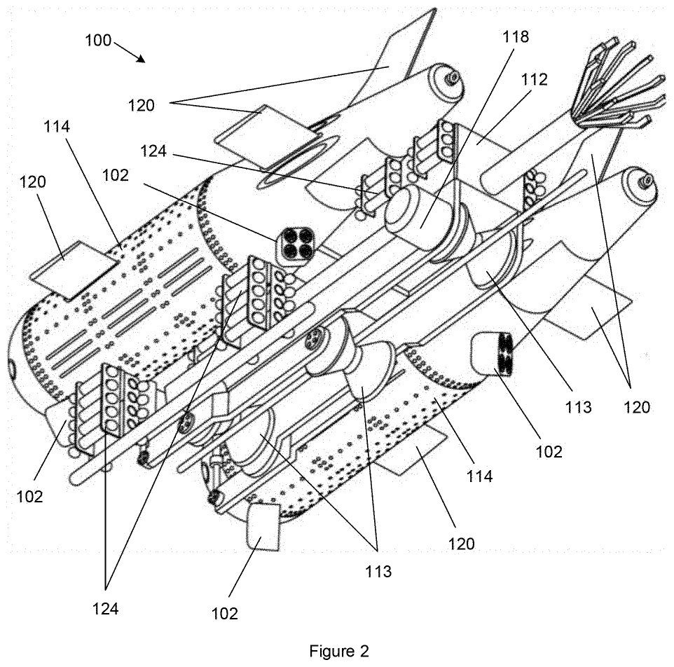

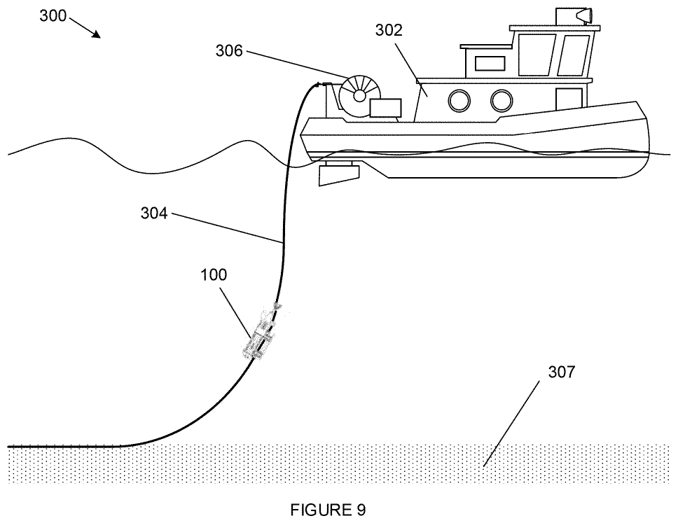

The engagement formation (104) of the device (100) may be configured to removably secure the device to an underwater cable as illustrated in FIG. 9. In a preferred embodiment, the engagement formation (104) may include a plurality of v-groove wheel bearings (113) configured to receive at least part of the cable and secure the device (100) to the cable, as shown in FIG. 2. Adjacent wheel bearings (113) may be offset such that the adjacent wheel bearings engage opposite sides of the cable, thereby effectively partially enclosing the cable, or holding it captive, so as to secure the device thereto. In some embodiments, the engagement formation (104) may be a clasp/clip having a diameter greater than that of the underwater cable and configured to secure the device to the underwater cable by securing the clasp/clip around a portion of the body of the cable. In further embodiments, the engagement formation (104) may be a groove or slot extending at least partway along a body (114) of the device (100) for receiving the cable and capable of sealing off or securing to the cable when a part of the body of the cable has been received in the groove.

The engagement formation (104) may be configured to accommodate movement of the device (100) relative to the underwater cable. This may, for example, be achieved by a series of bearings or rollers, such as v-groove wheel bearings. Accordingly, the underwater cable may be used as a guide rail/line and anchor, similar to that of a train and track configuration, so as to ease/facilitate navigation of the device (100).

It should be appreciated that in some embodiments, the engagement formation (104) may be configured to allow the device (100) to at least have limited free movement whilst being secured to the underwater cable. For example, the engagement formation may include a fastener, such as a clasp or a hook, and a tether, such as a cord. One end of the tether may be connected to the fastener and the other end to the device (100) allowing the device to have limited free movement around a connection point to the cable.

In real-world application underwater navigation can become challenging due to environmental challenges such as the pressures, currents, lack of vision, etc. to which the device (100) is exposed. By using the underwater cable as a guide rail/line, the impact of such environmental challenges may be mitigated, and navigation of the device (100) may be improved substantially.

The device (100) may include a safety mechanism (not shown) configured to enable release of the device from the cable in pre-determined situations. The safety mechanism may be configured to, in response to a predetermined pressure, temperature, drag force, or any other potentially unwanted force, acting on the device, release or break away from the cable so as to prevent damage to the device (100). The safety mechanism may form part of the engagement formation (104) or may simply be an independent safety mechanism. For example, in an embodiment in which the engagement formation (104) is a clasp type engaging formation (104), the safety mechanism may be a gate member located at a distal end of the clasp, such than when the gate member opens, the device (100) is free to be released from the cable and move independently.

In some embodiments, the safety mechanism may be located at a near end of the clasp and configured to enable separation of the device and the clasp. In such an embodiment the safety mechanism may be a breakaway point which is specifically designed to withstand predetermined conditions, such as pressures, forces or temperatures and when such predetermined conditions are exceeded, the safety mechanism may allow the device to break away from the engaging formation (104) and move independently. In an embodiment in which the engaging formation (104) is a set of v-groove wheel bearings, at least some of the wheel bearings may be configured to allow release of the device from the cable.

As discussed above, the device (100) is capable of being used in underwater applications at considerable depths at which navigation and control of the device may become increasingly difficult or at times even impossible. Manual navigation of the device (100) towards the surface when the device has been released from the cable, by means of the safety mechanism, may therefore be undesirable or impractical. Accordingly, the safety mechanism may be configured to include a component, such as buoyancy control components, a scaled down inflatable chamber, or the like, which facilitates return of the device from the point where it has broken away from the cable to the ocean surface. In an example embodiment the safety mechanism may include an inflatable chamber which may inflate by means of a compressor activated upon activation of the safety mechanism. The inflatable chamber may allow the device to return to the surface of the ocean, where the device can be retrieved. The safety mechanism may further be configured to transmit a distress signal, such as a homing signal, flashing LED's, or the like, enabling a user to locate the device (100) when the device has surfaced.

The safety mechanism may be in communication with a computing unit (106) provided in the device (100). The computing unit (106) may be configured to record and process output data/sampling data received from the one or more sampling elements (102) located in or on the device (100). For example, the safety mechanism may receive a signal from the computing unit (106) in communication with a pressure sensor that a predetermined pressure has been exceeded. In response to the signal received, the safety mechanism may cause the device (100) to be released from the cable as explained in more detail above. In some embodiments, the safety mechanism may be controlled by means of a control unit in communication with the computing unit (106). An example embodiment of such a control unit is described in more detail below.

The one or more sampling elements (102) may include any one or more of a camera, a temperature sensor, a pressure sensor, a depth sensor, sound emitter and receiver pairs, radar, a micro particle analyser, a timing device, such as an I555 timer, for generating timing data, a radiation tester, nitrate and phosphate tester, or the like. It should be appreciated that the device (100) may include one or more of each sampling element (102) or, alternatively, that the device may only include one sampling element such as a camera. It should also be envisaged that the device (100) may be equipped with other devices such as tension sensing elements, speed sensors and/or the like. It should be appreciated that while some of the sampling elements (102) may be mounted on external surfaces of the device (100), the sampling element accessories, such as circuitry including regulators, processors, memory, drivers, or the like, may be located in the casing (112) or body (114) of the device.

Each one of the one or more sampling elements (102) may be configured to operatively sample parameters relating to the underwater environment. For example, where the sampling element is a camera, the camera may be a 360-degree camera configured to record parameters of an area surrounding the device, whilst a radar or sound emitter and receiver pairs, such as sonar, may be used to map the seabed. It should be appreciated that each sampling element (102) may be pre-configured to capture different parameters and to operate as desired.

The output of one or more of the sampling elements (102), configured to record data, may be transmitted to the computing unit (106), as and where appropriate. The computing unit (106) may receive the output and process the data. Processing the data may include converting the data into readable instructions for use in another component or to generate a set of data which may be associated with the device (100) or a specific deployment of the device. For example, each device may have a computing unit (106) having a unique identifier and an internal clock which may be used to record the exact time and date at which at least one or more of the sampling elements (102) delivered a specific output. The output data of the specific sampling element may therefore be associated with the exact time and date, i.e. real-time, at which the output was recorded using the device (100). The unique identifier of the processor may be used to identify the device from which the data was obtained and may include any one or more of: a serial number, make, model or a date associated with the device, such as a date when the device was manufactured.

The computing unit (106) may be configured to transmit the output data of one or more of the sampling elements (102) to a storage component (108). The storage component (108) may be an on-board storage component provided in or on the device (100), or it may be a remote storage component, such as a database, which is maintained at a remote computing device, such as a remote server, personal computer, laptop or the like.

In an embodiment in which the storage component (108) is a database maintained at a remote server, the database may include a record associated with the specific device (100). The record may store the unique device identifier and the recorded output data. In such an embodiment the storage component (108) may include a receiver for receiving the data.

The computing unit (106) may include a communication component including a communications interface for operation of the computing unit (106) in a networked environment enabling transfer of data between computing units and/or to the remote computing device. Data transferred via the communications interface may be in the form of signals, which may be electronic, electromagnetic, optical, radio, or other types of signal. The communication component may enable transmission of data between the computing unit (106) and the remote computing device.

It should be appreciated that the computing unit (106) may be configured to communicate with the storage component (108), or any of the other sampling elements (102), through connections such as Bluetooth, a serial port and a variety of other interfaces to ultimately connect components of the device (100).

It is well known that a body of water such as the ocean may distort signals which may make communication between above surface and sub-surface devices particularly complex. Accordingly, the communication component may be configured to transmit data, such as the recorded output data, to the remote computing device via a repeater provided in the underwater cable. Most of the existing underwater cables have repeater units along its length which may be used to transmit signals. Generally, such repeater units are spaced approximately 15-150 km apart. Each of the repeaters located in the underwater cables may be configured to amplify or reconstruct signals to be relayed from one device to another. Accordingly, the communication component may be configured to communicate with the remote computing device, by transmitting signals, such as the output data, to the remote computing device over a frequency matching that of each specific repeater unit.

Accordingly, to maintain privacy and prevent unauthorised access, such as signal interception, of the data signals transmitted via the repeaters located in the underwater cables, the data may be encrypted. The transmitted data signals may include a security key associated with the specific device from which the data is transmitted. For example, the encrypted security key may be a public key associated with the device (100) and include a hash of the device serial number or the like. The remote computing device, or a user thereof, may receive and decrypt the encrypted data signal using a private key associated with the device. In some embodiments, the data may simply be password protected allowing only authorised entities to gain access to the data.

In some embodiments the device (100) may include both an internal and external storage device that interfaces with the computing unit (106). The data stored on the internal storage device may be used as a backup of the output data or simply as a buffering space for upload to the remote database. For example, in an embodiment in which the connection between the external storage device and the computing unit (106) is disrupted, the internal storage device may record the data and store the data. The internal storage device's storage capacity may be limited to only capture data of a single deployment of the device (100) during cable recovery. It is also foreseen that the device may record all recorded data on the onboard storage unit and when the device is periodically raised to the surface, for example when it reaches one of the repeaters in the cable, the data on the onboard storage unit may be downloaded onto a larger storage facility onboard a vessel before it is deployed again on the next section of cable.

The device (100) may further include a control unit (116) in communication with the computing unit (106). The control unit (116) may be configured to control movement of the device (100) when the device is in use. The control unit (116) may receive control instructions from the computing unit (106) in response to output data received by the computing unit (106) from the one or more sampling elements (102). In order to control movement of the device (100) and enable an operator of the device to navigate the device, the control unit (116) may be in communication with a plurality of navigation components, such as a stabilising mechanism, propelling mechanism (118), such as a mechanical drive and gear assembly, or the like. For example, the device (100) may include a drive and gear assembly, enclosed in a drive housing (118), which may be used to propel the device in a preferred direction up or down the cable. The drive and gear assembly may, for example, drive an electric motor which, in turn, facilitates rotation of the v-groove wheel bearings, to propel the device in response to a control signal being received at the control unit (116). It will be appreciated that such a mechanical v-groove wheel-based drive may allow for precision movement of the device along the cable. The device (100) may further include a plurality of fins (120) which may be used to steer the device.

In some embodiments, the propelling mechanism may comprise one or more bow thrusters, azimuth thrusters, or the like, configured to propel the device in response to a signal being received at the control unit (116). The thrusters may also be used to steer the device.

The stabilising mechanism may be a gyroscope configured to stabilise the device (100) during data capturing, sample collection and/or navigation. It should be appreciated that the control unit (116) may be used to control the safety mechanism in response to instructions received from the computing unit (106).

The device (100) may be powered by at least one power source (110), such as a battery. The battery (110) may be a removable battery which may be recharged or replaced by an operator of the device (100). In some embodiments, the device (100) may at least be partially self-powered. For example, the engaging formation (104) may include a power generating unit (not shown), such as a dynamo, configured to generate power in response to frictional movement between the device (100) and the underwater cable. The power generating unit may convert the mechanical power created by cable drag into electrical energy which may be used to power the device. The power generated by the power generating unit may be used to directly power the device and/or to recharge the battery (110) during use of the device. The power generating unit may be located on an outer surface of the device. For example, if the device includes an engaging formation (104), such as a clasp and one or more v-groove wheel bearings which engage with the cable during use, the power generating unit may be connected to the wheels. The power generating unit may be directly connected to the components of the device or, alternatively, connected to the battery (110). In an embodiment in which the power generating unit is directly connected to the components of the device, additional power components such as regulators or inverters may be provided. The regulators may be used to ensure that the current and/or voltage has an amplitude within the power ratings of the device components whereas the inverters may be used to convert the obtained power from AC to DC or vice versa.

The battery may be any chargeable battery (110), such as a lead acid battery, lithium-ion battery, saltwater battery, or the like. The power generating unit may store the generated power/energy in the battery (110) until such time that it is needed.

It should be appreciated that, in practice, the battery (110) may be housed to protect the battery from external factors. In the example embodiment shown, the battery is housed in the casing (112) of the device.

In some embodiments, the device (100) may be powered form the underwater cable by means of an electrical connection between the device and the cable itself. The cable may include a copper coating capable of distributing power to various components, such as repeater units, of the cable. Accordingly, the device (100) may be configured to harvest at least some of the power to charge a battery (110) by means of an electrical terminal configured to facilitate electrical connection between the device and the cable. It should be appreciated that components of the device may be in direct connection with the electrical terminal and as such may be powered by the cable directly.

The device (100) may include at least one high-intensity light, such as a high-intensity LED (126) which may facilitate subsea recording operations. Preferably, the device (100) may include an array of LEDs (126). Such an LED array may increase visibility and accordingly improve data captured by the sampling elements (102), such as picture quality of a camera.

A person skilled in the art would appreciate that, in some embodiments, the parameters to be sampled by the one or more sampling elements are physical parameters. In which case the one or more sampling elements (102) may include one or more sample collectors, such as a manipulator arm, a suction sampler, a detritus sampler, or the like, which may be used to collect underwater samples. A suction sampler may for example be used to collect soil samples, the manipulator arm for plant materials and the detritus sampler for organisms such as zooplankton. Each one of the one or more sample collectors may be in electrical communication with the control unit (116) which may be used to activate and control the relevant sample collector when a sample is to be collected. Any samples collected by means of the one or more sample collectors may be retrieved as the device is retrieved from the ocean waters. The collected samples may, for example, be stored in sample storage locations (124) provided along a body (114) of the device (100).

In some embodiments, the body (114) of the device (100) may define storage locations for larger samples that may be collected, to house additional sensors, electronics, safety equipment, or the like. The body (114) of the device may further be shaped and configured to allow minimum resistance to movement of the device in the water. For example, the body (114) may include a plurality of water passage channels to guide water through the body (114) and aid movement of the device (100) when submerged. In practice the channels may be provided with filters to prevent ingress of unwanted particles, such as marine algae. In some embodiments, the body may house bow thrusters, azimuth thrusters, or the like, in the water passage channels to facilitate movement of the device (100).

Embodiments in which the device (100) includes numerous additional sensors and features may also be envisaged. For example, in certain embodiments the device may include a location determining device, such as a Global Positioning System (GPS) device or a device using similar location determining techniques such as a Global Navigation Satellite System (GLONASS), a Beidou or Galileo (satellite navigation) system. In some embodiments, a telematics device or tracking device for remotely tracking the device may be provided. It should be appreciated that the location determining device may be controlled and monitored from the remote computing device. The location determining device may be in electronic communication with the computing unit (106) which is in communication with the remote computing device. The computing unit (106) may be configured to associate the location data with the output data received from the one or more sampling elements (102) and combine the data into a data package. The data package may be transmitted to the storage component (108). Associating the location data with the output data may enable an end user to, for example, identify the exact location and time that the specific data was recorded.

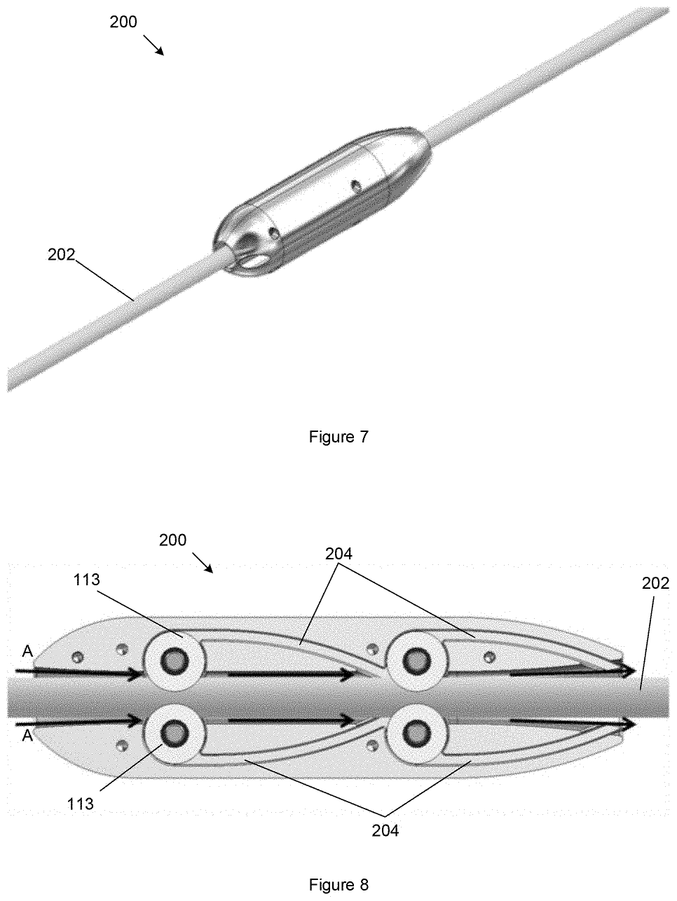

It should be appreciated that in some embodiments, a control unit is not required as navigation of the device may purely be facilitated by the cable. For example, in some embodiments, the device may be a compact, heavy device, of approximately 120 kg, configured to be removably secured to a cable and guided towards a bottom of the cable by means of gravity. FIGS. 7 and 8 illustrate a second example embodiment of a device (200) for underwater data capture, wherein the device is a compact, weighted device configured to move down the cable (202) by means of gravity only. In these figures like features to those referred to with reference to FIGS. 1 through 6 are indicated by like numerals.

The engagement formation of the device may be a set of v-groove wheel bearings (113) configured to engage the cable (202) at opposite sides thereof, so as to secure the device (200) to the cable. The v-groove wheel bearings (113) may be configured to include channels (204) for water displacement so as to facilitate water flow through the device in one direction only, as indicated by the arrows (A), and thereby improve movement of the device along the length of the cable. The engagement formation (104) may be configured such that when a repeater located on the cable (202) is reached, the device (200) becomes anchored and unable to navigate further down the cable. The device (200) may be retrieved by recovering the cable (202), or the device may include one or more components, such as buoyancy control components, a scaled down inflatable chamber, or the like, which facilitates return of the device (200) to the surface.

FIG. 9 is a diagrammatic representation illustrating an example system (300) in which an underwater sampling device (100/200) as described above may be used. The system (300) may include a vessel (302) from which the device is to be deployed, the device (100/200), in its preferred position, and an existing underwater cable (304).

The vessel (302) may be an underwater cable recovery vessel equipped with motorized winch components (306) configured to recover cables from the ocean floor (307). In practice, successful underwater cable recovery may be a long and complex process. For the sake of clarity, an example recovery process is briefly described below.

A cable recovery shipping vessel (302) may be deployed to a predetermined location at which a known underwater cable (304) is laid on the ocean floor (307). The shipping vessel (302) may make use of a cutting grapnel, or a hook, in order to cut, or raise and then cut, the targeted underwater cable (304). Once the cable (304) is cut, the cutting grapnel may be recovered to the vessel (302). After recovery of the cutting grapnel, a holding grapnel may be deployed into the ocean waters. This holding grapnel may be lowered onto the ocean floor on a rope and dragged along the ocean floor until one end of the cut cable (304) is engaged. The engaged cable (304) may then be raised to the surface and recovered on board the vessel (302). In most recovery operations an end of the raised cable may then be attached to a buoy (306) which marks the end of the cable. The same process may then be followed in order to recover the other end of the cable.

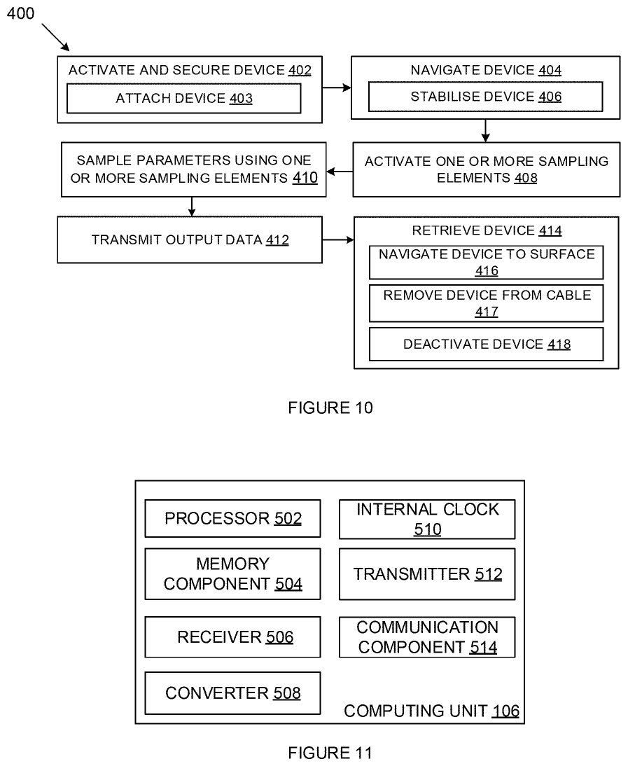

In the flow diagram in FIG. 10, there is shown an example of a method (400) of deploying the device (100) in a cable recovery system (300). The method may be conducted by one or more end users/operators of the device (100). It should be appreciated that the method is merely an example method and different steps may be performed for different embodiments.

A cable recovery crew, or any other responsible party, may initiate the cable recovery process which includes the steps described with reference to FIG. 9. After the cable (304) has been lifted off the ocean floor (307) and an end thereof has been attached to the winch (306) for hauling of the cable, the device (100) may be activated and secured (402) to the underwater cable (304). Securing (402) of the device (100) to the underwater cable (304) may either be a manual operation, in which an end user, or a user authorised by the end user, attaches (403) the device to the cable by means of the engaging formation (104). In some embodiments, the device may be placed into the water and by means of the control unit be steered/navigated towards the cable and attached (403) to the cable. Then, when the device (100) has been secured (402) to the cable (304), the device may navigate (404) down the cable by means of gravity or its propelling mechanism (118) to its preferred location. In practice, the cable (304) will form a catenary under its own weight during the recovery process. Considering the nature of the catenary and that it allows the device (100) to move up and down the cable without much difficulty, the preferred location of the device (100) may be along the catenary.

As soon as the device (100) has reached its preferred location the device may be stabilised (406) at the location by means of the stabilising mechanism and cable recovery may take place by winching the cable upwards. As the cable (304) is winched upwards, the device may be propelled along the cable. Effectively, the device (100) may be seen to remain stationary relative to the vessel (302) but moves laterally relative to the ocean floor (307), along the cable as the cable is winched upwards towards the vessel, similar to that of a thread and needle configuration. As the cable runs through the engaging formation of the device (100), the device may generate its own power due to frictional force caused by relevant movement of the device and the cable. The generated power may be harvested and used to power the one or more sampling elements (102). The one or more sampling elements may be activated upon activation of the device, in some embodiments, the sampling elements may be activated (408) remotely by means of the remote controlling device. When the one or more sampling elements (102) have been activated (408) the elements (102) may sample parameters (410) relating to their environment. It should be appreciated that step (406) discussed above is optional and, as such, it is not an essential requirement for the device to be stabilised during sampling of underwater parameters. It is simply a preferred step in a method of sampling underwater parameters.

The device (100) may transmit (412) signals, including the output data/sampling data, of the one or more sampling elements (102) to the remote computing device every time that a repeater unit is detected. It should be appreciated that the repeater units often have an increased diameter in comparison to that of the underwater cable (304). Accordingly, the device may not be able to navigate/move past the repeater unit in some embodiments in which the engagement formation (104) is a clasp type engagement formation. Considering the above, it is envisaged that the repeater unit may be used as a lifting mechanism for lifting the device (100) towards the surface during winching of the cable (304). As soon as the repeater unit nears the winch, the device (100) may be disconnected from the cable (304) and re-attached to the cable on an opposite side of the repeater. In such an embodiment the steps discussed above may be repeated for the length of the cable. It should of course be envisaged that the engaging formation of the device may be configured to at least partially release the cable when a repeater is detected/reached, so as to enable the device to navigate past the repeater, if preferred. For example, if the cable has a shallow repeater an operator may wish to move past the repeater, accordingly, the device may be configured to navigate past the repeater by at least partially disengaging the cable and moving over the repeater. As soon as the device has cleared the repeater, the device may re-engage the cable as before.

At the end of the recovery process, or as soon as preferred, the device (100) may be retrieved (414). Retrieving the device (100) may include an operator of the device navigating (416) the device towards the ocean surface, where the device may be removed (417) from the underwater cable (304) and deactivated (418). In some embodiments, the device may simply be configured to grip onto the cable so that it may be lifted to the surface, and the vessel, along with the cable.

As mentioned throughout the specification, the device (100) may be used in underwater applications at considerable depths. In such applications the environmental factors, such as pressures and temperatures, may be so extreme that navigation of the device becomes burdensome. Accordingly, the device may be navigated (416) towards the ocean surface by merely engaging one of the repeater units along the length of the cable and winching the cable upwards. The repeater unit may effectively “push” the device (100) towards the surface where the device may be retrieved. Once the device (100) has been raised to the vessel the data recorded on the device's onboard storage unit may be downloaded onto a larger storage device on the vessel, before the device is re-attached to the cable and deployed again.

In an embodiment in which the storage component (108) is a database at a remote location, such as the vessel or a location on land, the end user may be a remote server. The remote server may deactivate the device and access the data by for example, logging into an interface using a username and password associated with the party recovering the device and collect the data which is stored on the database for subsequent analysis.

Due to the nature of cable recovery, the data capturing device may be deployed and secured to the cable for the duration of the recovery process.

As previously mentioned, it should be appreciated that the underwater cable (304) need not be a pre-existing underwater cable and it may be a custom weighted cable configured to be deployed into a body of water. In such an embodiment the cable may be connected to a cable retrieving component, such as a winch, at one end and an opposite end of the cable may be released into the ocean. The cable will fall towards the ocean floor due to its own weight or a weight, such as a sinker, attached to the end of the cable released into the water. As soon as the cable has been deployed at a preferred location, the device (100) may be activated and secured to the cable, as described in the method steps above.

It should be appreciated that the same method steps (402) up to (412) as described above may be repeated to record underwater environmental data with a custom weighted cable. The cable may be configured to include similar materials to that of existing underwater cables, such as copper, which may be used to power the device (100).

Retrieval of the device (100) and recovery of the cable may also follow similar steps to the method steps (414 to 418) as described above. For example, the cable may include a stopper, which may be used as a lifting mechanism, similar to the repeater of existing underwater cables, that may press against the device (100) in response to hauling of the cable during recovery.

Components of the computing unit (106) are shown in the high-level block diagram in FIG. 11. The computing unit (106) may include a processor (502) for executing the functions of components described below, which may be provided by hardware or software units executing on the computing unit. The software units may be stored in a memory (504) which provide instructions to the processor (502) to carry out the functionality of the described components. The memory (504) may have the unique identifier associated with the device (100) stored therein.

The computing unit (106) may include a receiver (506) arranged to receive output parameters of the at least one or more sampling elements (102). Each output may be an electrical signal associated with the specific sampling element. The output may be an amplified output according to processing signal standards. The computing unit (106) may include a converter (508) to convert the output to data readable by other components in communication with the computing unit (106), such as the control unit (116). The output data may include real-time data provided by an internal clock (510) of the computing unit (106) so as to effectively time-stamp the outputs of the one or more sampling elements (102) and associate the outputs with a specific time and date at which it was obtained.

The computing unit (106) may include a transmitter (512) arranged to transmit data to one or more of a communication component (514), a storage component (108) and a control unit (116). The output data may be transmitted to a storage component (108) associated with the device (100) by means of the communication component (514). The communication component (514) may be arranged to communicate with the remote computing device, by transmitting the output data received from the computing unit (106) to the remote computing device over a frequency matching that of a repeater unit located in an underwater data cable.

The control unit (116) may be arranged to control the stabilising mechanism, the safety mechanism and the propelling mechanism (118) of the device in response to data received from the computing unit (106).

It should be appreciated that updated technologies may replace some of the functions and components of the device. For example, the storage component (108) may be a physical storage device such as a USB storage device, however, it should be appreciated that the device may have wireless capabilities and the storage device may be replaced by cloud storage maintained by a remote server described throughout the specification.

It is clear that various applications for an underwater sampling device as described herein may exist. Due to the wide application of such a device, it should be appreciated that various combinations of components and configurations may be envisaged which do not steer away from the essence of the invention. Accordingly, the protection sought by the invention aims to cover such derivative embodiments which merely include added accessories such as digging arms, a different body shape or the like.

In practice, each ocean and sea have different conditions that need to be dealt with and overcome. For example, certain oceans have different temperatures and different pressures which may attract certain forms of ocean life or promote the growth of certain underwater plants etc. Such information could be of specific importance for studies relating to climate change, fish movement patterns and the identification of new species.

The device may be used to automatically record and log the sampling parameters/data captured by the relevant sampling components. The data obtained over an extended period, i.e. the historic data stored in the database, may be used to analyse and determine the performance of the device in specific conditions and environments. The average temperatures in certain oceans and depths may be calculated with the obtained data.

The recorded and logged data may form a basis for feedback on the oceans and ocean conditions which may be useful not only for scientific purposes, but may also be used in industry, by governments, conservationists, and regulatory bodies.

The foregoing description has been presented for the purpose of illustration; it is not intended to be exhaustive or to limit the invention to the precise forms disclosed. Persons skilled in the relevant art can appreciate that many modifications and variations are possible in light of the above disclosure. For example, it should be foreseen that an additional data and/or power cable may be attached to the device and used for power and/or communication between the device and the vessel. While this will obviously introduce complications due to the depths at which the device is expected to operate, such an implementation is not outside the scope of this invention. As a further example it is foreseen that the device may have at least some measure of freedom from the undersea cable by, for example, enabling the device to momentarily detach from the cable, operate within a certain range of the cable, and re-attach to the cable for further operation. In such an embodiment the device may be provided with a tether to a moveable connection point which remains attached to the cable, so as to alleviate the possibility of the device being unable to re-attach to the cable in becoming lost in the process.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A device for sampling underwater parameters, the device comprising an engagement formation for removably engaging an underwater cable and one or more sampling elements configured to operatively sample the underwater parameters, wherein the device is configured to move along the underwater cable to where the cable is positioned underwater.

2. The device as claimed in claim 1, including a computing unit in communication with the one or more sampling elements, wherein the computing unit is configured to receive output data from one or more of the sampling elements and record the output data as and where appropriate.

3. The device as claimed in claim 1, wherein the device is removably secured to the underwater cable by means of the engagement formation, the engagement formation being configured to accommodate movement of the device relative to the underwater cable.

4. The device as claimed in claim 1, wherein the engagement formation includes at least one v-groove wheel configured to engage the cable and guide the device along a length of the cable.

5. The device as claimed in claim 1, wherein the device is powered by the underwater cable via an electrical connection created between the device and the cable.

6. The device as claimed in claim 1, including a power generating unit configured to power the device and/or recharge a battery configured to power the device during use of the device.

7. The device as claimed in claim 6, wherein the power generating unit is a friction power generating unit configured to generate power in response to frictional movement of the device along the underwater cable.

8. The device as claimed in claim 1, wherein the one or more sampling elements include one or more of: a camera; a sensor; sound emitter and receiver groups; radar; a micro particle analyser; soil, water or sample collectors; and a timing device for generating time data.

9. The device as claimed in claim 2, wherein the computing unit includes a storage component for recording the output data from one or more of the sampling elements.

10. The device as claimed in claim 9, wherein the storage component is an on-board storage device.

11. The device as claimed in claim 9, wherein the storage component is a database maintained at a remote computing device.

12. The device as claimed in claim 11, including a communication component configured to transmit the output data to the remote computing device via a repeater provided in the underwater cable.

13. The device as claimed in claim 11, including a location determining device controlled and monitored from the remote computing device, wherein the location determining device is configured to determine the location of the device and transmit location data to the computing device so as to associate the location data with the output data and to record and store the location data and the output data on the storage device.

14. The device as claimed in claim 1, including either or both of: a stabilising mechanism for facilitating accurate navigation of the device, and a safety mechanism configured to, in response to a predetermined pressure or temperature acting on the device, release the device from the underwater cable so as to prevent damage to the device.

15. The device as claimed in claim 14, including a controlling unit in communication with the computing unit for navigating movement of the device.

16. The device as claimed in claim 15, wherein the stabilising mechanism and/or the safety mechanism is controlled by the controlling unit.

17. The device as claimed in claim 1, wherein the device is a portable device manufactured from a corrosive resistant material having a high strength to density ratio.

18. A method for sampling underwater parameters with an underwater sampling device, the method comprising the steps of:
releasably securing the sampling device to an underwater cable;
navigating the sampling device along the length of the underwater cable; and
sampling underwater parameters using one or more sampling elements configured to operatively sample underwater parameters during navigation of the sampling device along the length of the underwater cable.

19. The method as claimed in claim 18, including transmitting sampling data, including sampled underwater parameters, to a storage component and recording the sampling data to a database.

20. The method as claimed in claim 19, including: securing the sampling device to a raised end of the underwater cable; allowing the sampling device to move down the cable towards a submerged section of thereof; periodically raising the sampling device to the vessel; and retrieving recorded sampling data from the sampling device while the device is in close proximity to or on the vessel.
